(19) United States
(12) Patent Application Publication
(10) Pub. No.: US 2025/0178179 A1
(43) Pub. Date: Jun. 5, 2025

(54) COMPACT PNEUMATIC HAMMER POSITIONER

(71) Applicant: R.N.P. INDUSTRIES INC., Rigaud (CA)

(72) Inventors: Danny MORISSETTE, St Colomban (CA); Erick SMITH, Blainville (CA)

(21) Appl. No.: 18/962,057

(22) Filed: Nov. 27, 2024

Related U.S. Application Data
(60) Provisional application No. 63/604,288, filed on Nov. 30, 2023.

(51) Int. Cl. B25H 1/00; B25D 17/28

(52) U.S. Cl. CPC B25H 1/0042; B25D 17/28; B25H 1/0028; B25D 2250/391

(57) ABSTRACT

A tool positioner for a chipping or drilling tool having a tool axis. The positioner has a frame, a tool support configured for coupling the chipping or drilling tool to the positioner and mounted to the frame via a first joint having a first pivot axis and a second joint having a second pivot axis, the first pivot axis, the second pivot axis and the tool axis intersecting each other at a common point. The first joint and the second joint allow angular movements of the chipping or drilling tool at least about the respective first pivot axis and the second pivot axis. The tool support is further displaceable relative to the frame to enable a plurality of degrees of freedom in translation of the tool support. An automated locking system is operable to restrict and allow the plurality of degrees of freedom in translation of the tool support.

### CROSS-REFERENCE TO RELATED APPLICATION(S)

The present application claims priority on U.S. Patent Application Ser. No. 63/604,288 filed on Nov. 30, 2023, the entire content of which is incorporated herein by reference.

### TECHNICAL FIELD

The present disclosure relates generally to industrial-scale drilling/chipping tools and, more particularly, to devices used for self-standing support and positioning of such tools.

### BACKGROUND

Vehicle-mounted hydraulic or pneumatic rigs for supporting and positioning a drilling/chipping tool, such as a jackhammer or drilling machine, during vertical or overhead chipping and/or drilling operations are known, but are typically complex, expensive, cumbersome, or otherwise not suitable for applications of a smaller scale or a confined space. For these smaller scale operations, hand-held drilling/chipping tools may be manipulated by an operator to manually perform the drilling or chipping work.

The positioning and orientation of such tools call upon human eye-hand coordination, and such tools are often heavy to handle and cumbersome to manipulate. They also transmit powerful vibrations to the hands and body of the operator. Devices for positioning a pneumatic hammer or the like for drilling/chipping walls or ceilings may still require the operator to support much of the weight, and to absorb high vibratory loads. Repeated exposure often cause fatigue or injury.

### SUMMARY

It is an object of the present disclosure to provide a tool positioner enabling spatial positioning and a multi-directional orientation of a tool such as a pneumatic drilling or chipping tool more easily and efficiently. The tool positioner may support the weight of such tool, provide a tool engagement bias against the working surface during use to eliminate or reduce the need for manual positive loading of the tool against the working surface, and be humanly displaceable and limit transmission of vibration generated by the tool to the tool operator. It is also an object of the present disclosure to provide a relatively compact and lightweight tool positioner to facilitate transportation and versatility. The tool positioner may be easily disassemble/assemble. For transportation from site to site and installation in confined spaces, the modularity of the design, in at least some cases, may be advantageous.

In one aspect, there is provided a tool positioner for a chipping or drilling tool having a tool axis, comprising: a base frame; a mast extending upwardly from the base frame, the mast rotatable about a mast axis; a carriage engaged with the mast and displaceable relative to the mast along the mast axis; a lateral displacement member engaged with the carriage and displaceable relative to the carriage along a transverse axis; a tool arm extending from the lateral displacement member, the tool arm being articulated via a first joint between a first member and a second member; and a tool support pivotally mounted to the tool arm via a second joint, the tool support adapted to receive the chipping or drilling tool.

Further in accordance with the above aspect, for example, the tool positioner further comprises an automated locking system operable to selectively restrict and enable multiple degrees of freedom of the tool support, the automated locking system configured for preventing a relative movement between the mast, the carriage and the lateral displacement member, the automated locking system activated upon actuation of the chipping or drilling tool.

Further in accordance with the above aspects, for example, the automated locking system includes a caliper and a disc rotatable relative to the caliper, wherein the caliper pinches the disc upon actuation of the caliper to lock rotation of the mast about the mast axis.

Further in accordance with the above aspects, for example, the automated locking system includes a clamp mounted to the carriage, the clamp, in an active position, engaging with the lateral displacement member to prevent movement of the lateral displacement member relative to the carriage.

Further in accordance with the above aspects, for example, the clamp and the caliper are actuatable via respective pneumatic actuators.

Further in accordance with the above aspects, for example, the first joint defines a first pivot axis, the second joint defines a second pivot axis, and the tool support defines a position and an orientation of the tool axis, and wherein the tool axis intersects with at least one of: the first pivot axis and the second pivot axis.

Further in accordance with the above aspects, for example, the tool axis intersects with both the first pivot axis and the second pivot axis.

Further in accordance with the above aspects, for example, the tool arm is securable to the lateral displacement member in an elevated mounting position and in a low mounting position, in the elevated mounting position the tool arm projects upwardly relative to the lateral displacement member.

Further in accordance with the above aspects, for example, the tool arm is pivotally mounted to the lateral displacement member via a third joint, the third joint lockable to selectively secure the tool arm in at least one of the elevated mounting position and the low mounting position.

Further in accordance with the above aspects, for example, the tool support includes a fixed member, a tool carriage displaceable along a tool axis relative to the fixed member, and an actuator operable to displace the tool carriage along the tool axis.

Further in accordance with the above aspects, for example, the tool positioner further comprises a control unit including a pressure regulation valve configured to select a mode of operation between a low pressure mode and a high pressure mode, wherein in the low pressure mode, a pneumatic pressure delivered to the actuator is lower than a pneumatic pressure delivered to the actuator in the high pressure mode.

In another aspect, there is provided a tool positioner for a chipping or drilling tool having a tool axis, comprising: a frame; a tool support configured for coupling the chipping or drilling tool to the tool positioner, the tool support mounted to the frame via a first joint having a first pivot axis and a second joint having a second pivot axis, the first pivot axis, the second pivot axis and the tool axis intersecting each other at a common point, the first joint and the second joint allowing angular movements of the chipping or drilling tool at least about the respective first pivot axis and the second pivot axis, the tool support further displaceable relative to the frame to enable a plurality of degrees of freedom in translation of the tool support; and an automated locking system operable to restrict and allow the plurality of degrees of freedom in translation of the tool support.

Further in accordance with the above aspect, for example, the automated locking system is operable simultaneously upon actuation of the chipping or drilling tool.

Further in accordance with the above aspects, for example, the angular movement about the first pivot axis varies a pitch angle of the tool axis and the angular movement about the second pivot axis varies a yaw angle of the tool axis.

Further in accordance with the above aspects, for example, the frame includes a mast having a mast axis extending generally vertically, and a lateral displacement member displaceable along the mast axis to displace the tool support in translation therealong to allow a first one of the plurality of degrees of freedom in translation.

Further in accordance with the above aspects, for example, the lateral displacement member is further displaceable relative to the mast along a transverse axis, the transverse axis extending transversely relative to the mast axis to enable a second one of the plurality of degrees of freedom in translation of the tool support.

Further in accordance with the above aspects, for example, the mast is rotatable relative to the mast axis whereby a rotation of the mast causes a displacement of the tool support in a transverse direction relative to the mast axis.

Further in accordance with the above aspects, for example, the frame includes a carriage engaged to the mast and displaceable relative thereto along the mast axis, the carriage supporting the lateral displacement member.

Further in accordance with the above aspects, for example, the automated locking system includes an override mechanism configured to override a pneumatic supply of the automated locking system, the override mechanism including one or more mechanical locks to prevent any movements between the mast, the carriage and the lateral displacement member.

In yet another aspect, there is provided a method for operating a tool positioner for a chipping or drilling tool having a tool axis, the tool positioner having a frame and a tool support, the method comprising: positioning the chipping or drilling tool relative to a working surface, including: actuating a weight compensation system to move the tool support in translation relative to the frame along a first axis; moving the tool support in translation relative to the frame along a second axis transverse to the first axis; angularly displacing the tool support to cause a variation of at least one of a pitch angle and a yaw angle of the tool; and activating an automated locking system to prevent any further movements along the first axis and the second axis to restrict a first degree of freedom in translation and a second degree of freedom in translation of the chipping or drilling tool prior to or simultaneously with initiating drilling or chipping.

### BRIEF DESCRIPTION OF THE DRAWINGS

Reference is now made to the accompanying figures in which:

FIG. 1 is a perspective view of a tool positioner according to an embodiment;

FIG. 2A is a magnified perspective view of a portion of the tool positioner of FIG. 1;

FIG. 2B is a perspective view of a portion of the tool positioner of FIG. 1, in a partially exploded state to visually reveal features thereof;

FIG. 3A is a perspective view of a portion of the tool positioner of FIG. 1, with components shown with transparency to reveal features thereof;

FIG. 3B is a partial cross-sectional view of a portion of the tool positioner of FIG. 1, with components shown with transparency to visually reveal features thereof;

FIG. 3C is a magnified perspective view of components of the portion of the tool positioner shown in FIG. 2B.

FIG. 4A is another perspective view of the tool positioner of FIG. 1;

FIG. 4B is perspective partial view of the tool positioner of FIG. 1, in a reversed configuration;

FIG. 5A is another perspective view of the tool positioner of FIG. 1;

FIG. 5B is another perspective view of the tool positioner of FIG. 1, illustrating different mounting positions of a tool arm of the tool positioner;

FIG. 6A is an exploded perspective view of a tool support of the tool positioner of FIGS. 1 to 5, according to an embodiment;

FIG. 6B is a perspective view of the tool support of FIG. 6A, with components hidden to visually reveal features thereof; and

FIG. 7 is a perspective view of a control unit of the tool positioner of FIG. 1 according to an embodiment.

### DETAILED DESCRIPTION

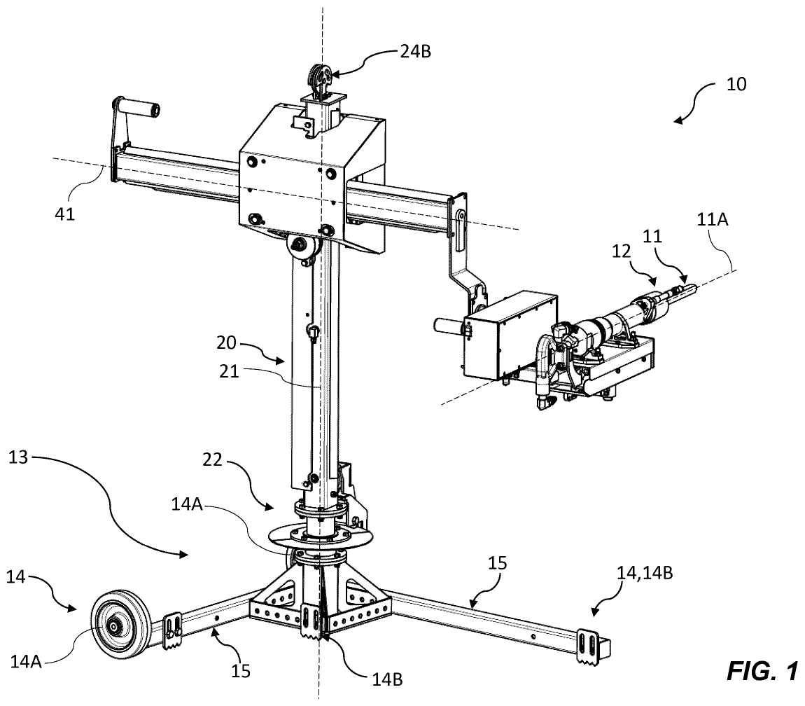

FIG. 1 illustrates a tool positioner 10 according to the present disclosure. The tool positioner 10 is adapted to position and support a tool 11 for drilling or chipping. In an embodiment, the tool 11 has a pneumatic-controlled reciprocating bit that reciprocates along a tool axis 11A (percussion axis or drill axis). The reciprocating displacement may be actuated pneumatically, though other options could be contemplated, such as electricity. It should be understood that the tool axis 11A could be referred to as drilling axis, in variants of the tool 11 which includes a rotating drilling bit and operable for drilling holes.

In at least some embodiments, the tool 11 may be equipped with an airborne dust management system 12 which may release a water mist ahead of the reciprocating bit to humidify the airborne dust in the vicinity of the working area and/or on a working surface thereby reducing the dust in the surrounding environment of the operator. In one embodiment, mist may be activated only when the tool 11 is operating (e.g. the reciprocating bit powered by compressed air and is in reciprocating mode). The system 12 may include an on-board water mist system and associated control valves. The system 12 may be automatically activated along with the actuation of the tool 11. An exemplary airborne dust management system 12 is further described in U.S. patent application publication no. 2016/0136799, the entire content of which is incorporated herein by reference.

In an embodiment, the tool 11 is a pneumatic jackhammer and may be used for wall or ceiling chipping applications, for example. While the tool 11 could be handled manually by an operator, such type of tool as used in the industry are bulky and often heavy. Handling and operating such a tool over extended use may become burdensome and cause muscular fatigue or injury because of its weight and generated vibrations in operation. The tool positioner 10 is self-standing. The tool positioner 10 may allow to neutralize the tool weight in operation, and also reduce the vibrations transmitted to, and physical effort for, an operator when performing chipping/drilling. Indeed, in at least some embodiments, the tool positioner 10 may actively bias the tool 11 towards the working surface during use to take over, substantially if not entirely, the human effort to hold and press the tool bit against the working surface.

The tool positioner 10 may be relatively light, and may be manually displaceable and actuatable by the operator without or with limited assistance. In at least some embodiments, the tool positioner 10 may be sized to fit within a nacelle and be operated therefrom.

As will be described herein, the tool positioner 10 is actuatable to displace the tool 11 in various degrees of freedom, both in rotation and translation, so as to attack at various angles a working surface of a wall or ceiling. The tool positioner 10 is adapted to support the weight of the tool 11 and, upon actuation of the tool 11 for chipping/drilling, to minimize (or neutralize) the transmission of vibrations caused by the chipping/drilling action so as to limit the induced vibrations to the operator's hand(s) at a hand interface. Stated differently, the tool positioner 10 is adapted so as to absorb at least part of the vibrations generated by the chipping/drilling action, and substantially isolate the operator from such vibrations. The tool positioner 10 is also adapted to substantially minimize the human effort typically required to engage the tool 11 on the working surface. The tool positioner 10 may actively bias the tool 11 towards the working surface without or with limited effort from the operator. The tool work may therefore be substantially decoupled from the operator.

In operation, a number of degrees of freedom may be selectively blocked/released upon actuation of the tool 11 for chipping/drilling, while other degrees of freedom may remain free to allow the operator to manually aim at a desired zone to be chipped/drilled in the working area and/or working surface. During operation of the tool 11, the weight of the tool 11 may be substantially, if not entirely, supported by the tool positioner 10 such that the operator may actuate the tool 11 to initiate the chipping/drilling with limited effort while the tool positioner 10 supports the weight of the tool 11 and maintains the spatial positioning of the tool 11. In addition, the tool positioner 10 may actively bias the tool 11 towards the working surface without or with limited effort from the operator.

In at least some embodiments, the tool positioner 10 may not require any power unit or power assistance to actuate the various degree of freedoms thereof for spatially positioning the tool 11. The tool positioner 10 may be actuated manually by the operator to position the tool 11 mounted thereto relative to a working area and/or working surface. However, as described herein, in at least some embodiments the tool positioner 10 may include a weight compensation system to limit the operator's effort for manual displacement of the tool 11 against gravity.

The tool positioner 10 has a frame that includes a base frame 13. In the embodiment shown, the base frame 13 has at least three ground-engaging features 14 to support the tool positioner 10 on the ground. As shown, the ground-engaging features 14 may include wheels/rollers 14A and one or more posts 14B (also called legs). The ground-engaging features 14 are spaced along the ground surface at ends of frame members 15 to define a footprint of the base frame 13 on the ground. The relative positioning of the ground-engaging features 14 may allow freestanding of the tool positioner 10 and stability of the tool positioner 10 to maintain it in an upstanding position even when not supported by any external assistance. The base frame 13 may include mounting brackets, with or without ground engaging features 14, adapted for mounting the tool positioner 10 on a nacelle, a floor surface, or other mounting surface.

The frame of the tool positioner 10 also includes a mast 20 extending in a generally vertical direction. The mast 20 is pivotally mounted to the base frame 13 for rotation about a mast axis 21. Rotation of the mast 20 about the mast axis 21 may enable a rotation of the tool 11 at a free end of the tool positioner 10 about the mast axis 21. Such rotation may cause a displacement of the tool 11 in a direction having a vector transverse relative to the mast axis 21 and the transverse axis 41 (see below).

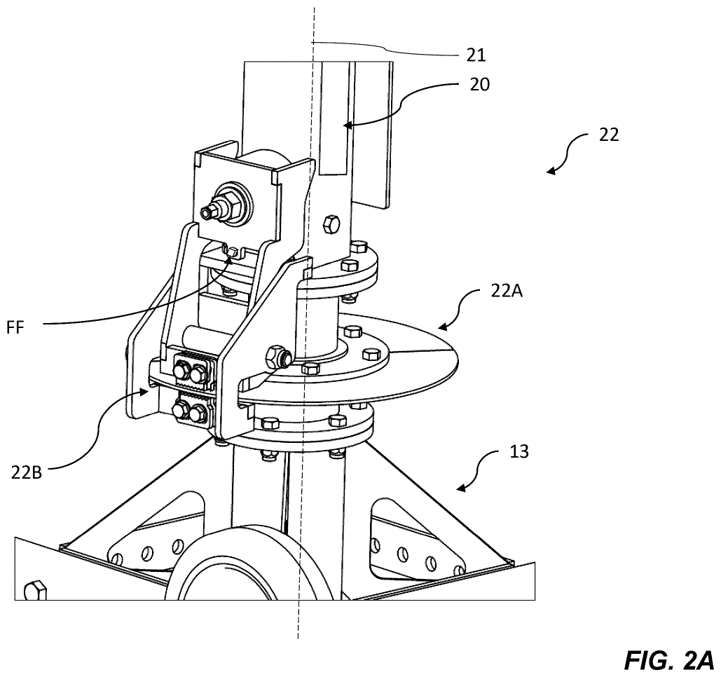

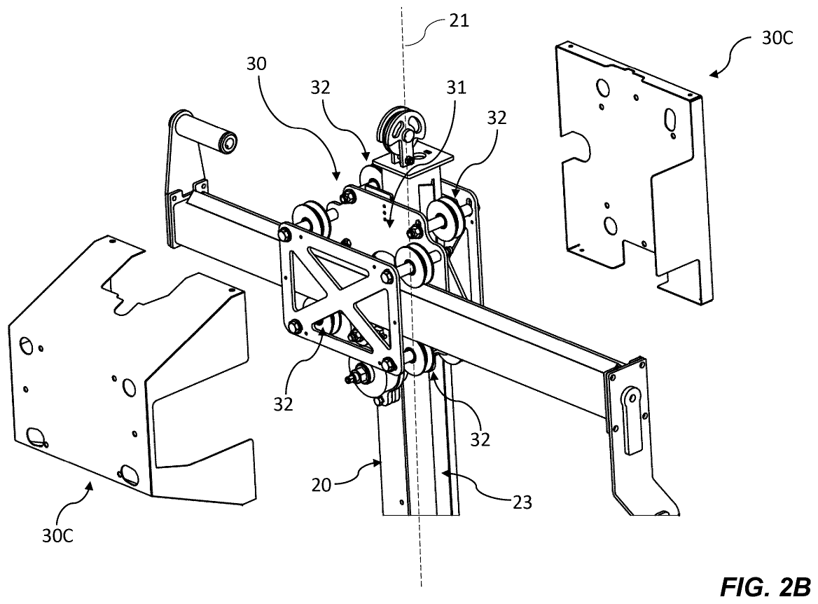

The mast 20 may include, or be part of, an automated locking system 22 to selectively prevent rotation of the mast 20 about its mast axis 21, when the automated locking system 22 is actuated. Referring to FIG. 2A, an embodiment of the automated locking system 22 may be a pneumatic brake system. The system 22 may be mounted serially between the mast 20 and the base frame 13. The system 22 may be considered part of the mast 20, or part of the base frame 13. In an embodiment, as shown, the system 22 includes a disc 22A mounted coaxially with respect to the mast axis 21. A pneumatic caliper 22B (which will also be referred to herein as a pneumatic clamp, or simply clamp) is fixedly mounted to the mast 20. The pneumatic caliper 22B could be fixedly mounted to the base frame 13 in some variants. The disc 22A may be rotatable relative to the pneumatic caliper 22B about the mast axis 21. Upon actuation of the pneumatic caliper 22B, the pneumatic caliper 22B may pinch the disc 22A, thereby preventing the rotation of the mast 20 about the mast axis 21. Accordingly, rotation of the tool 11 about the mast axis 21 is prevented, upon actuation of the pneumatic caliper or clamp.

As further described later, actuation of the tool 11 may concurrently actuate the automated locking system 22 to prevent the rotation of the mast 20 about its mast axis 21 during the chipping operation. The automatic locking system 22 may be released to regain the capacity to rotate about the mast axis 21 when the tool 11 is not actuated.

Referring to FIG. 2B, the mast 20 includes a rail or rail assembly 23, or other types of elongated guides, such as slot(s), rods, etc., that operatively engages with a carriage 30 mounted to the mast 20. The carriage is displaceable along the mast 20. The rail assembly 23 and carriage 30 may allow a degree of freedom in translation of the tool 11. A protective cover 30C may enclose, at least partially, the carriage 30. The protective cover 30C may limit dust or protect the carriage 30 and its moving parts against impact damages, and/or prevent/limit access for the operator's safety. As shown, the rail assembly 23 and carriage 30 allow a displacement of the tool 11 along the mast axis 21, which may correspond to a “up and down” displacement of the tool 11 relative to the ground or base frame 13 (FIG. 1). Any other relative displacement of the carriage 30 with respect to the mast 20 may be restricted, in at least some embodiments.

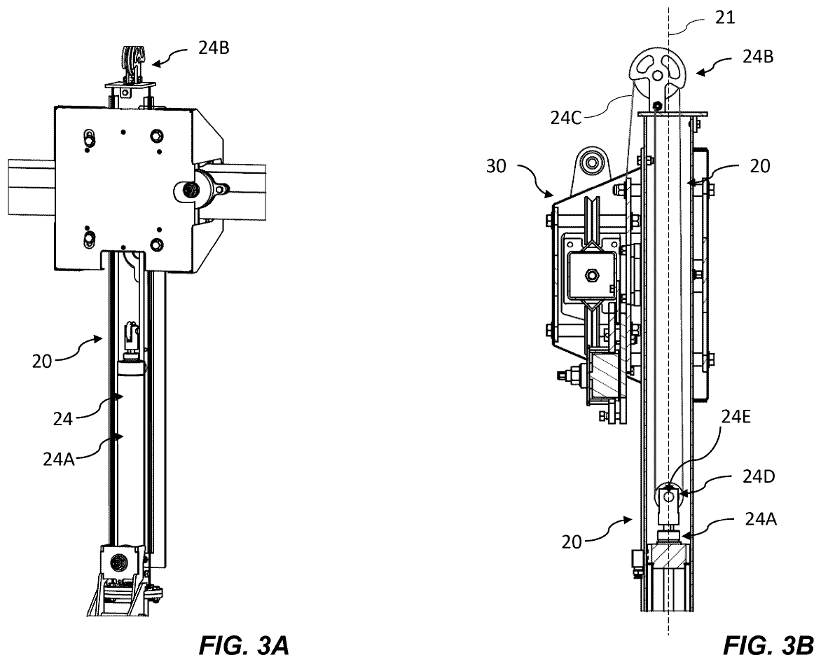

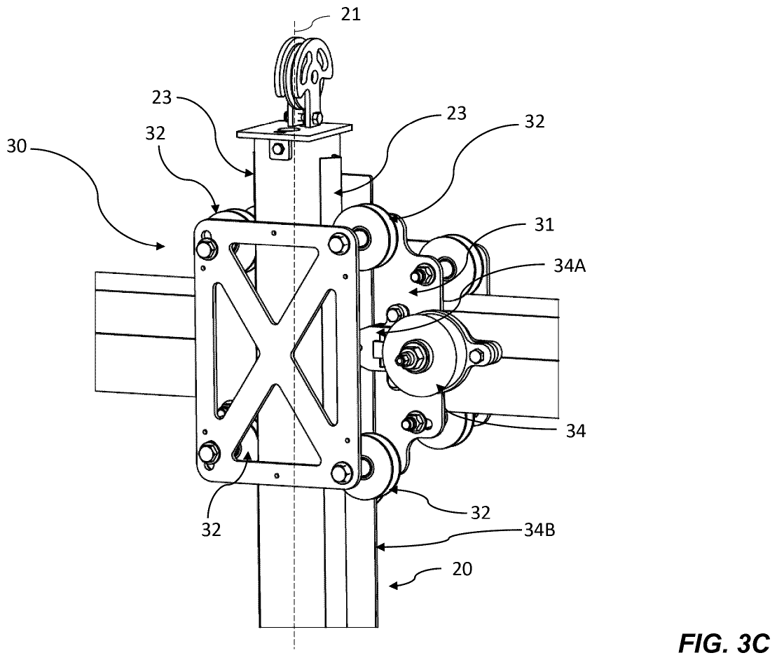

The carriage 30 may be manually displaceable along the mast axis 21. The operator may displace the carriage 30 along the mast 20 with limited effort. In an embodiment, a weight compensation system 24 may compensate for the weight of the moving components mounted (directly and indirectly) to the carriage 30 of the tool positioner 10, including the tool 11. Referring to FIGS. 3A-3B, in an embodiment, the weight compensation system 24 may include a pneumatic cylinder 24A extending along and/or enclosed within the mast 20. The pneumatic cylinder 24A is mounted to the mast 20, either directly or indirectly through intermediary components such as brackets, pins, etc. A pulley 24B is positioned at a top end of the mast 20, and a cable 24C (FIG. 3B) is engaged about the pulley 24B and fixed to the carriage 30 at one end. The cable 24C may be coupled to the carriage 30 (directly or indirectly) via intermediary hooks, loops, clips, anchors, fasteners or other cable connectors, for example. The cable 24C is operatively engaged to a moving end 24D of the pneumatic cylinder 24A, such that, upon actuation of the pneumatic cylinder 24A, the pneumatic cylinder 24A, via the cable 24C coupled to the carriage 30, may cause a displacement of the carriage 30 along the mast axis 21. The pneumatic cylinder 24A may reduce or eliminate the effort required by the operator to raise the carriage 30 and other movable components attached directly or indirectly thereto to displace it/them to position the tool 11 in a desired position in a up and down direction, by displacement of the carriage 30 along the mast axis 21. In an embodiment, as shown in FIG. 3B, the cable 24C may be coupled to the mast 20, e.g, at a top end. The moving end 24D of the pneumatic cylinder 24A includes a pulley 24E engaging the cable 24C. In the embodiment shown, such cable and pulleys arrangement may provide a 2:1 displacement ratio of the carriage 30 along the mast 20 and the displacement of the moving end 24D. This is only one possibility, as other possible configurations may be contemplated (e.g., arrangement providing a 3:1, 4:1 ratio). The weight compensation system 24 may therefore allow a displacement of the carriage 30 and the cantilevered components of the tool positioner 10 relative to the mast 20, without or with limited human work against gravity. Other arrangements than a cable 24C and pulley 24B may be contemplated. For example, a strap, a belt or a chain could also be contemplated to operatively link the cylinder 24A to the carriage 30. Similarly, other arrangements without a pulley 24B could be contemplated, such as an arrangement including a pinion, gear(s), for example as in a chain and pinion/gear arrangement. The pneumatic cylinder 24A is one possibility, though in variants, the weight compensation system 24 may include a gas spring, a spring, a spring damper, or other actuators, devices or mechanisms (e.g., an electrical winch, servomotor(s)) that may store and release energy or generate a force to selectively displace the carriage 30 along the mast axis 21 to work against gravity.

Referring to FIG. 2B and 3C, the carriage 30 is guided along the mast 20 via the rail assembly 23. In the embodiment shown, the carriage 30 includes rollers 32 engaged with the rail assembly 23 (here two rail segments on opposite faces of the mast 20). The rollers 32 may roll onto the rail assembly 23 and allow a displacement of the carriage 30 along the rail assembly 23. In the embodiment shown, the carriage 30 includes a frame 31, with two pairs of rollers 32 engaged with respective ones of the rail segments of the rail assembly 23, on opposite faces of the mast 20. Other arrangement are possible, e.g., more or less rollers 32, something else other than a rollers and rails arrangement, such as sliders and rails or slots, or rollers and channels arrangements, for example. In the embodiment shown, the rollers 32 have a rolling surface that has a concave shape so as to receive a top of the rail segments of the rail assembly 23 therein. As such, proper alignment between the rollers and the rail assembly 23 may be achieved. By displacing along the mast 20, the carriage 30 may cause the tool 11 at the free end of the tool positioner 10 to displace up and down.

The displacement of the carriage 30 relative to the mast 20 may be selectively prevented/allowed, in a similar manner as described above with respect to the rotation of the mast 20 about the mast axis 21. Referring to FIG. 3C, the tool positioner 10 may include another automated locking system 34 to selectively prevent the translation of the carriage 30 along the mast axis 21. The automated locking systems 22, 34 could be considered as part of a same system or as separate systems. In an embodiment, the system 34 includes a clamp 34A, which may be actuatable by a pneumatic actuator, operable between an active position, in which the clamp 34A may engage the mast 20 or a component thereof, and a release position, in which the carriage 30 may be free to displace relative to the mast 20 along the mast axis 21, upon actuation of the weight compensation system 24 (FIG. 3A-3B). Upon actuation of the clamp 34A, the clamp 34A may engage with the mast 20, in the embodiment shown a flat bar 34B extending along the mast 20, for example strong enough to prevent any movement between the mast 20 and the clamp 34A, thereby preventing the translation of the carriage 30 along the mast axis 21, and restricting the corresponding degree of freedom in translation of the tool 11. It is to be understood that an alternate structure (e.g. having a different shape or configuration) other than the flat bar 34B may be used for the same purpose. As shown in FIG. 3C, the clamp 34A may be mounted to the carriage 30. The clamp 34A may be mounted by a bracket, pins, and/or fasteners to the frame 31 of the carriage 30. While the locking is obtained via a pneumatic actuation of the automated locking system 34, this is only one possibility. In variants, the automated locking system 34 may include an electric actuation, and/or a magnetic locking instead of or in addition to the pinching action obtained from the actuation of the clamp 34A, for example.

As further described below, actuation of the tool 11 may concurrently actuate the locking system 34 to prevent the displacement of the carriage 30 along the mast axis 21 during the chipping operation. When the tool 11 is not actuated, the automated locking system 34 may allow the displacement of the carriage 30 along the mast axis 21 and the corresponding degree of freedom in translation of the tool 11.

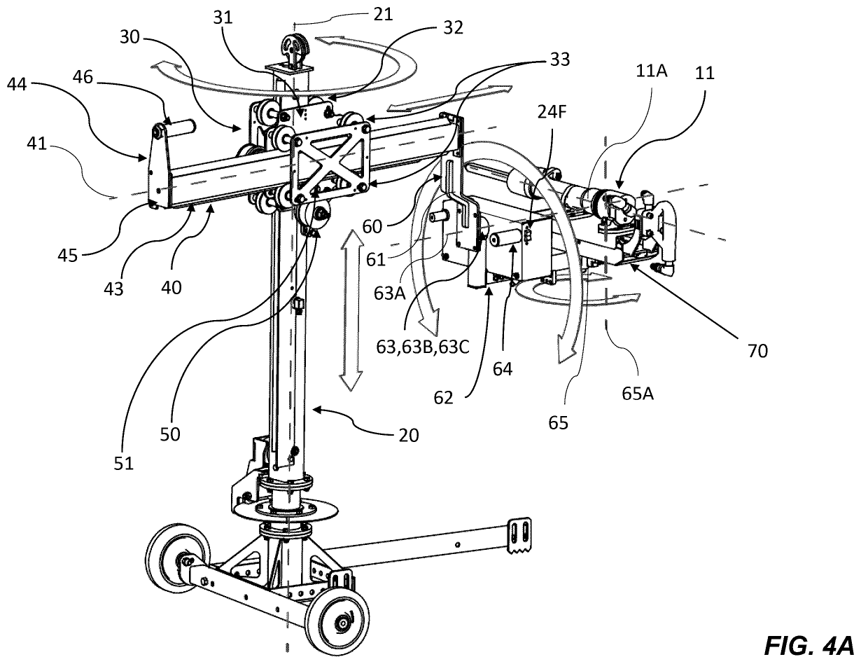

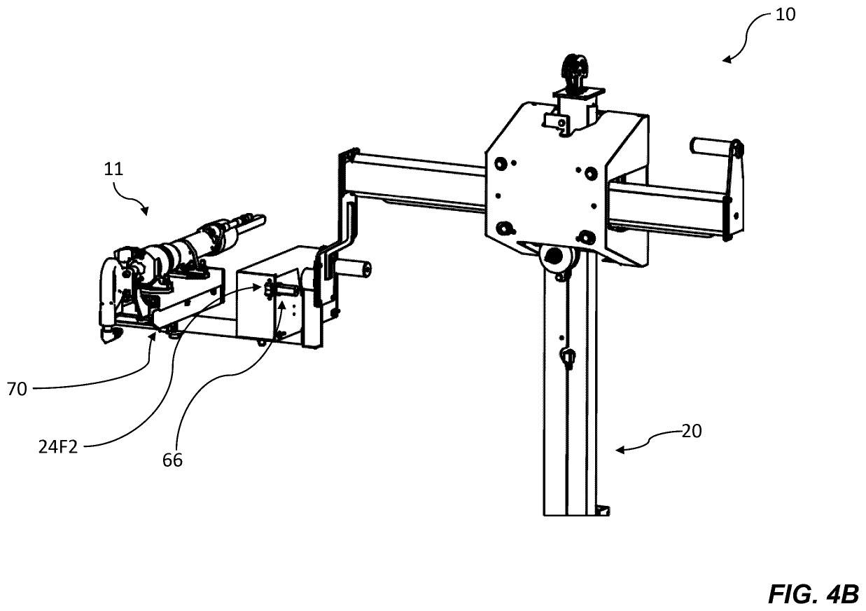

Referring to FIG. 4A, the carriage 30 may allow a second degrees of freedom in translation of the tool 11. The carriage 30 may allow a movement of the tool 11 in a direction that is transverse to the up and down direction discussed above, or stated differently, laterally (i.e., towards and away) with respect to the mast 20. As shown, the carriage 30 includes a second set of rollers 33 engageable with a beam 40 of the tool positioner 10. These rollers 33 may be configured similarly as the rollers 32 of the first set. The carriage 30 may allow a displacement of the beam 40 in a direction transverse to the mast axis 21. In the embodiment shown, the carriage 30 allows a displacement of the beam 40 in a direction that is normal to the mast axis 21. The carriage 30 may define a movable joint between the mast 20 and the beam 40, allowing a displacement of the beam 40 in translation along the mast axis 21 (e.g., up and down), and a displacement of the beam 40 relative to the carriage 30 and the mast 20 along a beam axis 41 (beam or transverse axis 41). A displacement of the beam 40 along its beam axis 41 may cause a corresponding lateral displacement of the tool 11, in a direction that is transverse to the up and down direction discussed above. These respective displacements allow two degrees of freedom in translation of the tool 11, namely a translation along the mast axis 21 and the beam axis 41. While the term “beam” is used throughout, such lateral displacement member could take other forms than a beam, such as a bar, a tube, a rod, or a subassembly/subframe extending transversely relative to the mast 20, supported by the carriage 30, and displaceable relative to the carriage 30 to move the tool 11 laterally toward and away the mast 20 along a transverse axis (transverse and/or normal) relative to the mast axis.

The beam 40 is guided relative to the carriage 30. The beam 40 includes a rail assembly 43, which is in the embodiment shown similar to that of the rail assembly 23 of the mast 20, though this is one possibility. The rail assembly 43, here including rail segments on opposite faces of the beam 40 are operatively engaged with the second set of rollers 33 of the carriage 30. Other guiding arrangement could be contemplated, such as sliders in slots, grooves, for example, to guide the movement of the beam 40 relative to the carriage 30.

As shown, the beam 40 includes abutments 44 (or “stoppers”) at opposite ends 45 thereof. The abutments 44 may abut against the carriage 30 once the carriage 30 reaches an end of the beam 40 so as to prevent any further axial displacement along the beam axis 41. As shown, in at least some embodiments, the beam 40 may include a handle 46 to facilitate the manual handling of the beam 40 and/or transportation of the tool positioner 10. The handle 46 may be part of the abutment 44 (or vice versa) or could be located elsewhere, in variants.

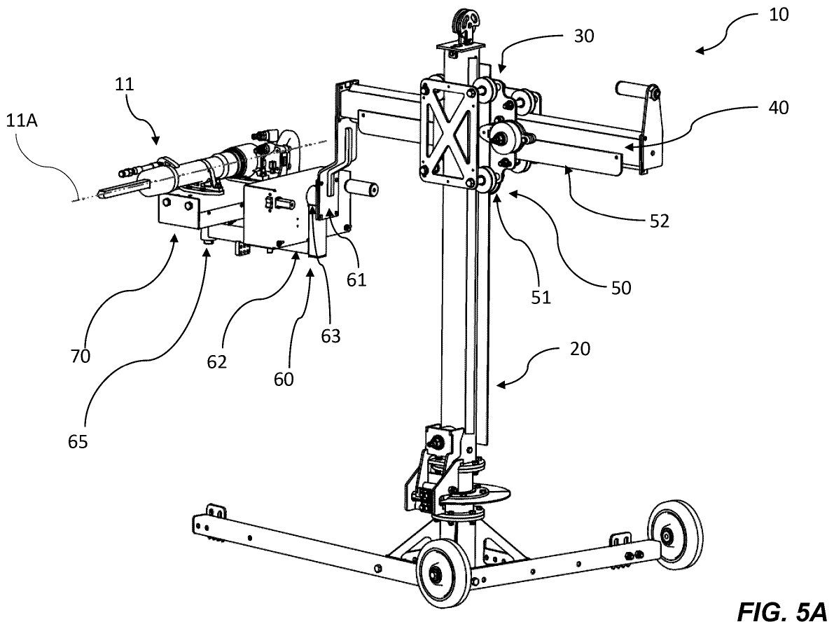

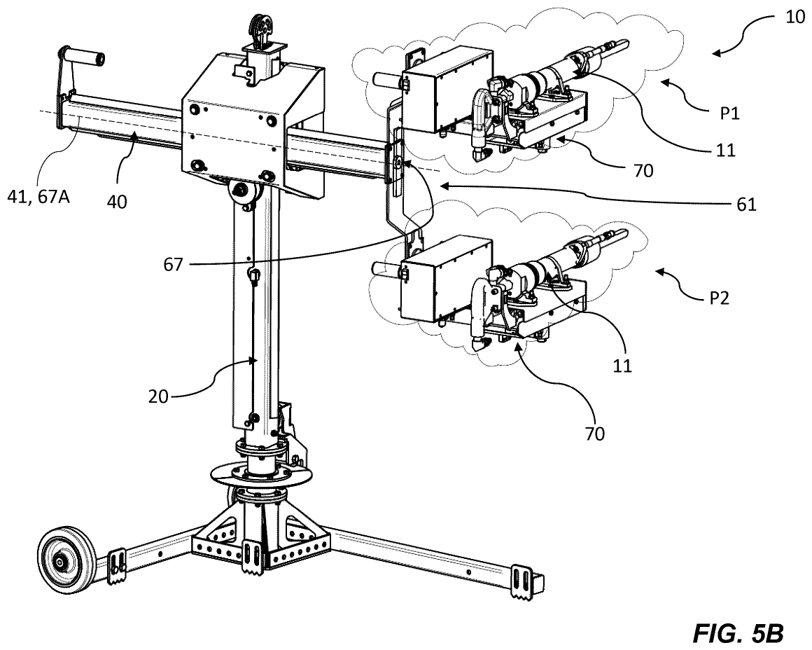

The displacement of the beam 40 relative to the carriage 30 may be selectively prevented/allowed in a similar manner as described above with respect to the rotation of the mast 20 about the mast axis 21 and the translation of the carriage 30 along the mast axis 21. Another degree of freedom in translation of the tool may thus be selectively restricted. Still referring to FIG. 4A, in at least some embodiments, the tool positioner 10 includes another automated locking system 50 to selectively the degree of freedom in translation of the tool 11 along the beam axis 41. The automated locking systems 22, 34, 50 could be considered as part of a same system or as separate systems. In an embodiment, the system 50 includes a clamp 51, which may be actuatable via a pneumatic actuator, operable between an active position, in which the clamp 51 may engage the beam 40 or a component thereof, and a release position, in which the beam 40 may be free to move relative to the carriage 30 along the beam axis 41. Upon actuation of the clamp 51, the clamp 51 may engage with the beam 40, in the embodiment shown a flat bar 52 (FIG. 5A) extending along the beam 40, for example strong enough to prevent any movement between the beam 40 and the clamp 51, thereby preventing the translation of the beam 40 along the beam axis 41, and restricting the corresponding degree of freedom in translation of the tool 11. The clamp 51 may be mounted to the carriage 30. The clamp 51 may be mounted by a bracket, pins, and/or fasteners to the frame 31 of the carriage 30.

In at least some embodiments, the locking system(s) 22, 34, 50 may include a pneumatic and/or mechanical override mechanism/mode (either passive or active) to prevent any movement between the mast 20, the carriage 30 and the beam 40 to facilitate transportation of the tool positioner 10 from one location to another. For example, in one mode of operation of the locking system(s) 22, 34, 50, the clamp, 22B, 34A, 51, may have a passive locking mode in which all clamps are biased into their locking state to prevent all relative movements between the mast 20, the carriage 30 and the beam 40. Such override of the locking system(s) 22, 34, 50 may mechanically lock the clamps by impeding their actuation and forcing the clamps to move into their locking state, without pneumatic supply to the systems 22, 34, 50. In other cases, the override of the locking system(s) 22, 34, 50 may be achieved by a separate mechanism. For example, in at least some cases, the override mechanism may include one or more mechanical locks to prevent, such as by mechanical interference/engagement, the relative movements of the mast 20, the carriage 30 and/or the beam 40. Such mechanical lock(s) may include, a pin, a fastener (e.g., screw, bolt), a latch, a bar, a padlock, a clutch, as some possibilities. For example, in the embodiment shown, the locking system 22 includes a fastener FF (FIG. 2A) that mechanically forces the clamp 22B to engage the disc 22A, without any pneumatic supply to the clamp 22B. The locking systems 34A, 51 may have the same or a similar fastener or mechanical override of the pneumatics to mechanically lock the clamps in their locking state. Such override of the locking system(s) could also be achieved pneumatically, for example by an arrangement of valves and pistons which, once the override is activated, can maintain a pressure and/or an engagement between moving parts of the locking system(s) until the override is deactivated (e.g., manual disengagement of the piston(s), manual opening of the valves, etc.).

With continued reference to FIG. 4A and additional reference to FIG. 5A, the tool positioner 10 has a tool arm 60 coupled to one of the ends 45 of the beam 40. The tool arm 60 is articulated. In the embodiment shown, a first member 61 of the tool arm 60 is mounted at the end 45 of the beam 40. In the embodiment shown, the first member 61 extends generally parallel to the mast 20, however this is optional. The first member 61 extends downwardly from the beam end 45. A second member 62 of the tool arm 60 is pivotally mounted to the first member 61 by a first joint 63, which in this embodiment is a pivot joint. The first joint 63 enables a rotation of the first member 61 relative to the second member 62. The second member 62 extends from the first joint 63, away from the mast 20. The tool 11 is mounted at a free end of the second member 62 by a second joint 65, as will be explained in further detail below.

The first joint 63 has a pivot axis 63A. In the embodiment shown, the first joint 63 includes an axle 63B and a sleeve 63C rotatable about the axle 63B. This is only one possibility for the first joint 63, which could include other types of joints, such as ball joint for example. In an embodiment, the pivot axis 63A may be normal to the mast axis 21. The first joint 63 enables a rotational movement of the tool 11 about the pivot axis 63A, thereby allowing a corresponding degree of freedom in rotation of the tool 11. In an embodiment, the pivot axis 63A may extend in a plane that intersect with the tool 11.

In the embodiment shown, in order to minimize the dynamic moment load induced during operation of the tool 11, the tool axis 11A intersects (or comes as close as possible to intersecting) the pivot axis 63A and the pivot axis 65A of the tool support 70. The tool axis 11A could also intersect with only one of the pivot axis 63A and pivot axis 65A in certain embodiments. It is to be understood that in practice, there may be minor offsets between two or more of these axes, however these offsets are to be minimized such as to ensure that they are as close a possible to intersecting each other as described. Such offset could for example be at most 50% of the maximum tool bit width in some cases. The offset could otherwise result in having one or both of the pivot axes 63A, 65A intersecting with a tool envelope defined by the tool or, stated otherwise, extending a plane intersecting with the tool 11 even if the plane does not precisely intersect the tool axis 11A itself. This prevents or minimizes moment induced forces during operation of the tool 11, which may be due to the reciprocating/drilling action of the tool bit and impacts or drilling therewith on the working surface. This configuration provides stability for the tool 11 and ultimately reduces the manual tool stabilization effort required from the operator during work. The pivot axis 63A may enable a degree of freedom in rotation for the tool 11. Since the pivot axis 63A may intersect with the tool axis 11A, as in the embodiment shown, or at least intersect with the tool envelope, the rotation about the pivot axis 63A may result in a rotation of the tool 11 relative to itself (e.g., about a point located “within” the tool envelope). In the depicted embodiment, the pivot axis 63A may be parallel or quasi parallel (±10 degrees) with respect to the beam axis 41, as in the embodiment shown. Other angular relationship could be contemplated, for example the pivot axis 63A could be oblique with respect to the beam axis 41.

The tool arm 60 may include a handle 64 for manual displacement of the tool arm 60 about the pivot axis 63A. In the embodiment shown, the handle 64 extends from a side of the case 81 of the control unit 80 (further discussed below). In variants, the handle 64 could include a bracket affixed to and/or projecting from the first joint 63. In the embodiment shown, a switch 24F of the weight compensation system 24 is mounted proximate to the handle 64 so as to allow the operator to actuate the weight compensation system 24. The handle 64 may be used by the operator to displace the tool arm 60 in space, which may include translational movement in or parallel to a plane defined by the beam axis 41 and the mast axis 21, as well as rotation about the mast axis 21. While it may also be possible to rotate the tool arm 60 about the pivot axis 63A using the handle 64, in practice it may be easier for a user to use the handle 75 (see below) mounted to the tool support 70 to modify the orientation of the tool 11 by pivoting the tool 11 about the pivot axis 63A and the pivot axis 65A.

As shown, a tool support 70 is pivotally mounted at the free end of the second member 62 by the second joint 65, which in this particular embodiment is a pivot joint. The second joint 65 enables another degree of freedom in rotation of the tool 11. The second joint 65 allows rotation of the tool support 70 with respect to the second member 62 to which it is mounted via the second joint 65. The second joint 65, or pivot joint in this embodiment, is located at the free end of the second member 62. The second joint 65 includes a rotation or pivot axis 65A. Pivot axis 65A and pivot axis 63A are non-parallel to each other, and in most embodiment will be normal to one another. Such second joint 65 may be configured the same way as the first joint 63 between first member 61 and second member 62. Such rotational movement of the tool support 70 with respect to the second member 62 may enable another degree of freedom in rotation of the tool 11 (i.e., other than the degree of freedom in rotation enabled by the first joint 63). In an embodiment, the pivot axis 65A is normal to the pivot axis 63A of the first joint 63. Rotation about the respective pivot axes 63A, 65A enables independent degrees of freedom in rotation of the tool 11. The tool arm 60 may therefore allow an orientation of the tool 11 in at least two degrees of freedom in rotation. Such orientation may be performed manually, by the operator.

The tool support 70 may thus be configured for coupling the chipping or drilling tool 11 to the tool positioner 10. The tool support 70 defines a position and an orientation of the tool axis 11A. The tool support 70 is mounted to the frame via a first joint 63 having a first pivot axis 63A and a second joint 65 having a second pivot axis 65A. The first joint 63 and the second joint 65 allow angular movements of the tool 11 at least about the respective first pivot axis 63A and the second pivot axis 65A. An angular movement of the tool 11 caused by a rotation at the first joint 63 may vary a pitch angle of the tool 11 and/or tool axis 11A. An angular movement of the tool 11 caused by a rotation at the second joint 65 may vary a yaw angle of the tool 11 and/or tool axis. The first pivot axis 63A, the second pivot axis 65A and the tool axis 11A may intersect each other at a common point. The tool axis 11A (or at least the tool envelope) of the tool 11 intersecting with the pivot axes 63A, 65A may neutralize the force moments that would otherwise be induced about these axes 63A, 65A by the reciprocating/or drilling action of the tool 11. In variants, the first and second pivots 63, 65 could be combined, e.g., physically stacked or formed by a single pivoting component such as a ball joint interfacing between the tool support 70 and the arm 60.

The tool positioner 10 may serve in wall or ceiling chipping/drilling applications. In some applications, for example, the working surface to chip/drill may be located above or at an elevation higher than the top end of the mast 20. Referring to FIG. 5B, in order to increase the reach of the tool in a heightwise direction, the tool arm 60 may be configured for mounting in an elevated mounting position P1 or a low mounting position P2, depending on the contemplated use. In an embodiment, the tool arm 60 may be coupled to the beam 40 via a third pivot 67. In the embodiment shown, the third pivot 67 has a pivot axis 67A that is parallel relative to the beam axis 41 (parallel and/or collinear). The tool arm 60 may thus pivot about the pivot axis 67A and/or the beam axis 41 to adjust the position of the tool 11 in a heightwise direction with respect to the beam 40. The third pivot 67 may be selectively locked in the elevated mounting position to fix the tool in that position, and prevent further rotation of the tool arm 60 about the beam and/or pivot axes 41, 67A. In the embodiment shown, the tool arm 60, in the elevated mounting position, may project upwardly relative to the beam 40. Locking at the third pivot 67 may be achieved in various ways, for example via a screw, a pin (lock pin), spring pin, latch, mechanical interlock, such as by engagement of a bayonet connection at the third pivot 67, clamping, etc. Stated differently, once positioned in the desired position, the third pivot 67 may be locked to prevent any further rotation at the pivot. In contrast, in the low mounting position, while keeping the carriage 30 at the same elevation along the mast 20, the tool 11 may be fixed in a lower position relative to the beam 40. In the embodiment shown, the tool arm 60, in the low mounting position, may project downwardly relative to the beam 40. In variants, the tool arm 60 may be non-pivotally coupled to the beam 40 yet still act as a reach extender by having more than one mounting position relative to the beam 40, with at least one mounting position where the tool 11 may reach a working surface at a higher elevation than the top of the mast 20 an/or where the tool support 70 is at an higher elevation than the beam 40. Such multi-configuration possibility for the tool arm 60 may provide more versatility in use while maintaining the overall compactness of the tool positioner 10.

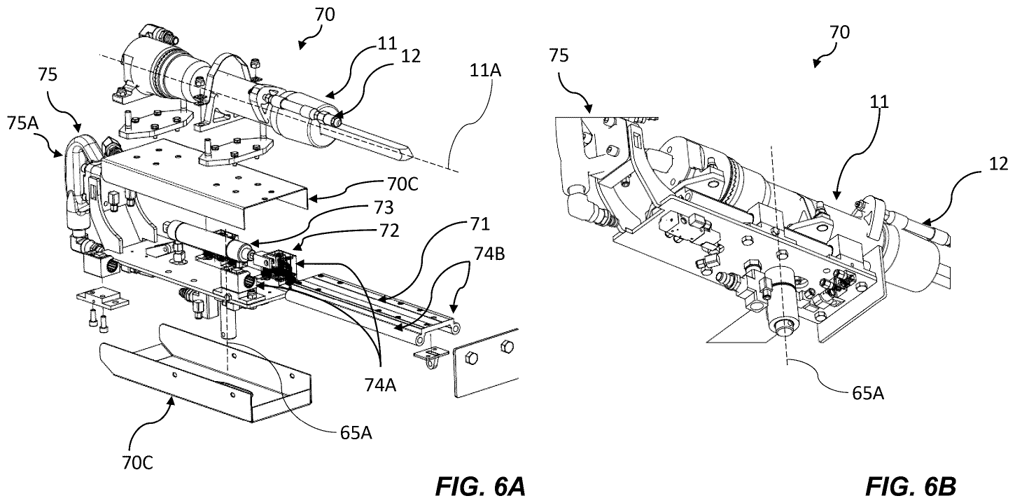

Now referring to FIGS. 6A-6B, the tool support 70 may include a tool carriage 71 for receiving the tool 11. Protective covers 70C may at least partially enclose the tool carriage 71, the fixed member 72 (described later), and/or other components of the tool support 70, such as the actuator 73 (described later). In an embodiment, the tool carriage 71 may be movable in translation relative to the fixed member 72. The tool carriage 71 may be in the form of a cradle on which the tool 11 may be secured, an example of which is described in U.S. patent application publication Ser. No. 14/899,474, the entire content of which is incorporated herein by reference. Such movement in translation may be aligned with the tool axis 11A. The direction of the translation may be oriented so as to be normal to the pivot axis 65A of the second joint 65 at the free end of the second member 62, as one possibility.

Referring to FIG. 6A, the tool carriage 71 may be slidably engaged with a fixed member 72 of the tool support 70. The tool carriage 71 may thus be a slidable carriage displaceable along the tool axis 11A. In the embodiment shown, a guide and rail arrangement interconnects the tool carriage 71 and the fixed member 72. As shown, the tool carriage 71 is slidably guided along a pair of guides 74A of the fixed member 72. In the embodiment shown, the tool carriage 71 has a pair of rails 74B which may slidably engage respective guides 74A of the fixed member 72. This guide and rail arrangement is only one possibility. For example, in variants, the guides 74A and rails 74B could be on the tool carriage 71 and fixed member 72, respectively, as another possibility. As shown, the tool support 70 includes an actuator 73 operable to displace the tool 11 along the tool axis 11A from an operating position, in which the tool 11 may be operated to chip or drill the working surface, and a non-operating position, in which the tool 11 may be biased or otherwise at rest when not in use. In the embodiment shown, the actuator 73 is a pneumatic actuator. The actuator 73 may define a vibration dampener by the inherent air compressibility properties. Upon actuation of the actuator 73, the tool 11 may displace along the tool axis 11A so as to approach the working surface to reach the operating position. The tool 11 may be activated, either subsequently or simultaneously as the tool 11 reaches the operating position. When the actuator 73 is activated and the tool 11 in use, the actuator 73 may, because of compressibility of air in its chamber, oppose at least partially to the recoil caused by the percussion on the working surface. The actuator 73 may thus act as a dynamic damper. In operation, the actuator 73 may decouple (or “isolate”) dynamically, at least partially, the tool carriage 71 from a remainder of the tool support 70 so as to limit the vibrations generated by the tool 11 propagating in the structure of the tool positioner 10, and/or to the interface with the operator operating the tool positioner 10. The actuator 73 may be at an interface between the tool carriage 71 and the fixed member 72 of the tool support 70. In a particular embodiment, the actuator 73 is a pneumatic cylinder. The pneumatic cylinder has approximately a 4-inch linear stroke, in a particular embodiment. Other actuators 73 could be contemplated, such as a hydraulic cylinder. When the actuator type permits, the actuator 73 could be coupled, serially or in parallel with, an elastomeric damper, a spring (e.g., coil spring, gas spring) or an assembly including one or more of these, for example, to dampen the vibrations cause by the tool 11 in use. In the embodiment shown, elongation of the pneumatic cylinder may move the tool 11 towards the working surface as the tool carriage 71 slides along the guides 74A of the fixed member 72. In at least some embodiments, the tool support 70 may include a handle 75 (FIG. 4A). The handle 75 could be part of the tool 11 itself as another possibility. The handle 75 may include an actuator 75A, such as a trigger or button, operable by the operator so as to control a pneumatic supply to the tool positioner 10 and tool 11. In an embodiment, the handle 75 and actuator 75A thereof may concurrently control the pneumatic supply to the tool 11, and the pneumatic supply (or other types of power source) to the automated locking systems 22, 34, 50 restricting respective degrees of freedom of the tool 11 during the operation of the tool positioner 10 and the tool 11. The actuation of the tool 11 and the automated locking systems 22, 34 50 may be substantially simultaneously (e.g. within milliseconds) with that of mist of water from the airborne dust management system 12, if present. In variants, this could be done sequentially instead of simultaneously.

In use, the tool positioner 10 may be operated by the operator as follows. The operator may position in the space the tool 11 by displacing manually, and/or by actuation of the weight compensation system 22, the tool 11 relative to the working surface. As described above, the carriage 30 may be displaced along the mast 20 by actuating the weight compensation system 22 to assist the manual displacement of the carriage 30 and other components displaceable along the mast axis 21 by such carriage 30. The beam 40 may be displaced relative to the carriage 30 along the beam axis 41, sequentially or simultaneously as the displacement of the carriage 30 along the mast 20 is performed. Yet, sequentially or simultaneously with these displacements of the tool 11 in the space, the operator may angularly displace the tool 11 about the mast axis 21. Once the desired position of the tool 11 is reached, the operator may, by holding the handle 75, activate the automated locking systems 22, 34, 50, which may prevent the movement between the mast 20, the carriage 30 and the beam 40 and the rotation of the mast 20 about the mast axis 21, thereby restricting substantially simultaneously the degrees of freedom in translation of the tool 11. In this state, the first and second joints 63, 65 may still allow freedom of movement about their respective axes 63A, 65A by manual displacement of the tool 11 by the operator holding the handle 75. The handle 75 may define the only interface between the operator and the tool positioner 10 when the tool 11 is put to work. The actuator 73 of the tool support 70 may be actuated by the operator, e.g., by pressing the actuator 75A of the handle 75 to displace the tool 11 along the tool axis 11A into the operating position. Once in such position, the chipping or drilling may be initiated, by activating the tool 11 (e.g., drilling or hammering). The tool 11 may be re-positioned between series of drilling/chipping, given that the locking systems 22, 34, 50 are released once the tool 11 is de-activated, thereby permitting full freedom of movement of the tool 11 in space.

Since the actuator 73, acting as a vibration dampener may take up at least part, e.g., a substantial part, of the vibration, and since the only interface between the operator and the tool positioner 10 may be at the handle 75, little vibratory energy may be transmitted from the tool positioner 10 and the tool 11 to the operator. Accordingly, the tool positioner 10 may neutralize both the tool weight and the main vibration source. The operator may thus focus on the task of drilling or chipping without or with limited effort to maintain the tool 11 in place, and with limited vibratory fatigue. In addition, in the operating position, the actuator 73 biases the tool 11 against the working surface during the drilling/chipping, thereby taking over substantially or all the work effort, leaving the operator to merely hold the handle 75 without engaging any positive drilling/chipping effort.

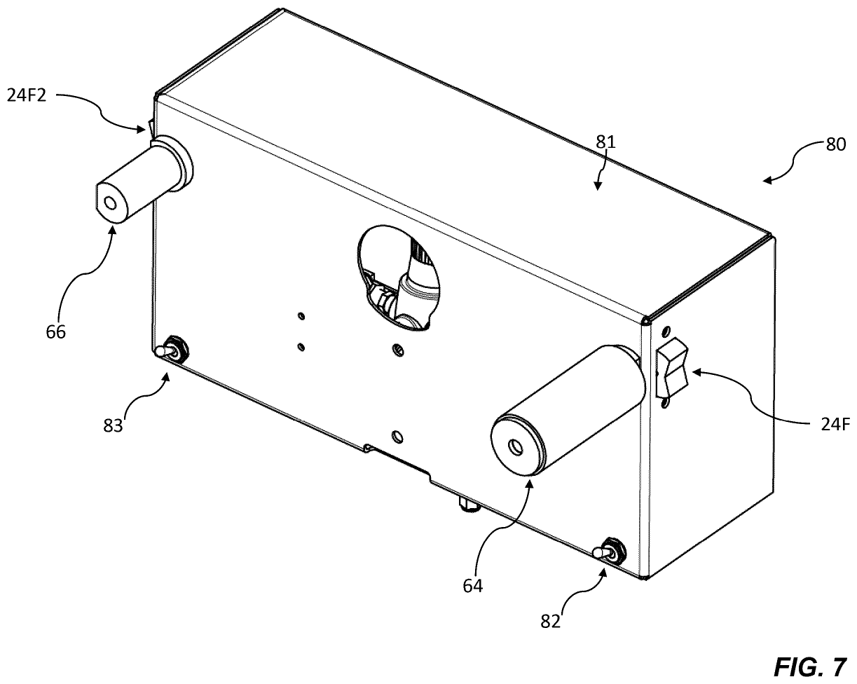

The tool positioner 10 includes a control unit 80. As shown, the control unit 80 is mounted to the tool arm 60, as one possibility. In variants, the control unit 80 could be part of the tool support 70 or mounted thereto. Referring to FIG. 7, in the embodiment shown, the control unit 80 includes a protective case 81. The protective case 81 may at least partially enclose pneumatic control components, such as valves, hoses, brackets, pressure regulators, and connectors and actuators (such as switches), forming parts of the pneumatic supply/control system of the tool positioner 10. The case 81 could also enclosed electronics and/or electric components, such as wires, circuits, etc. As shown, and mentioned above, the handle 64 extends from the protective case 81. The switch 24F is mounted to the protective case 81 for access by an operator having a hand on the handle 64, for example. As can be seen in FIG. 4B and in FIG. 7, there may be a second handle 66 extending from the protective case 81 and a second switch 24F2 mounted to the protective case 81. The second handle 66 and the second switch 24F2 located in proximity with the second handle 66 may allow even more versatility in the utilization of the tool positioner 10. In the FIG. 4B, the tool 11 is oriented in a reversed orientation relative to the orientation of the tool 11 shown in FIG. 4A. Stated differently, in FIG. 4A, the mast 20 is located on the left side of the tool 11, whereas, in FIG. 4B, the mast 20 is located on the right side of the tool 11. The second handle 66 and second switch 24F2 are located on an opposite side of the tool support 70 relative to the other switch 24F and handle 64 such that the operator may operate the tool positioner 10 and tool 11 with the mast 20 on its left or right hand side.

With continued reference to FIG. 7, the control unit 80 includes a valve 82 (e.g., switch valve) actuatable to activate the pneumatic clamps 22B, 34A, 51 of the locking system(s) 22, 34, 50 independently from the activation of the tool 11. An operator of the tool positioner 10, without activating the tool 11, may actuate the valve 82, manually, to activate the pneumatic clamping of the locking system(s) 22, 34, 50 to block all degrees of freedom between the mast 20, the carriage 30 and the beam 40. The valve 82 may thus allow a selective activation of the pneumatic supply to the clamps 22B, 34A, 51, without the activation of the tool 11.

In at least some embodiments, the control unit 80 of the tool positioner 10 includes a pressure regulation valve 83 configured to switch the pneumatic supply between different modes of operation. The pressure regulation valve 83 may be a switch valve, similar to the valve 82 described above. Upon actuation of the pressure regulation valve 83, the operator may select a low pressure mode or a high pressure mode for the operation of the tool support 70 (e.g., manual actuation by the operator). In the low pressure mode, pneumatic pressure delivered to the actuator 73 of the tool support 70 may be lower than the pneumatic pressure delivered to the actuator 73 in the high pressure mode. For example, in some embodiments, the pneumatic pressure in the low pressure mode is at least 10% lower than the pneumatic pressure delivered in the high pressure mode. The pneumatic pressure in the low pressure mode may be between 50% and 90% the pneumatic pressure in the high pressure mode. The low pressure mode may be selected for work involving drilling/chipping on a wall surface. Limiting the pneumatic pressure in the low pressure mode may limit the biasing force of the tool 11 on the working surface that is imparted by the actuator 73, hence the torque taken by the structure of the tool positioner 10 in reaction to the pressure of the tool 11 onto the working surface. This may allow a lighter and smaller design, and thus a more portable tool positioner 10. When the working surface is on a ceiling, more biasing force may be required to bias the tool 11 towards the working surface and also compensate for the weight of the tool 11 and the tool carriage 71. As such, the high pressure mode may be selected by the operator, if required, such as for ceiling drilling/chipping operations. Such dual mode of the control unit 80 is optional in at least some variants.

According to the above, a method for operating a tool positioner 10 for a chipping or drilling tool 11 having a tool axis 11A is now described. The method includes positioning the tool 11 relative to a working surface. Such positioning may include actuating a weight compensation system 24 to move the tool support 70 relative to the frame, along a first axis thereby allowing a first degree of freedom in translation of the tool 11. The tool support 70 may be positioned relative to the frame to allow a second degree of freedom in translation of the tool 11, by moving the tool support 70 in translation relative to the frame along a second axis transverse to the first axis. The first and second degrees of freedom in translation of the tool 11 are oriented orthogonally with respect to each other, with one degree of freedom in translation allowed by the constrained movement of the tool 11 along the first axis, namely the mast axis 21, and the other degree of freedom in translation allowed by the constrained movement of the tool 11 along a second axis transverse to the first axis, namely the beam axis 41. The tool support 70 is angularly displaced to cause a variation of at least one of a pitch angle and a yaw angle of the tool 11. An automated locking system is activated to prevent any further movements along the first axis and the second axis to restrict at least the first degree of freedom in translation and the second degree of freedom in translation of the tool 11 prior to or simultaneously with initiating the tool 11 for drilling or chipping. The positioning of the tool 11 relative to the working surface may further include rotating the tool support 70 about a rotation axis parallel to a movement direction of the first degree of freedom in translation. The activation of the automated locking system may further prevent rotation of the tool support 70 about the rotation axis parallel to the movement direction of the first degree of freedom in translation prior to or simultaneously with initiating the drilling or chipping.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments and aspects described in this document provide non-limiting examples of possible implementations of the present technology. Upon review of the present disclosure, a person of ordinary skill in the art will recognize that changes may be made to the embodiments described herein in view of the aspects described herein without departing from the scope of the present technology. Modifications could be implemented by a person of ordinary skill in the art in view of the present disclosure, which modifications would be within the scope of the present technology.

1. A tool positioner for a chipping or drilling tool having a tool axis, comprising:
a base frame;
a mast extending upwardly from the base frame, the mast rotatable about a mast axis;
a carriage engaged with the mast and displaceable relative to the mast along the mast axis;
a lateral displacement member engaged with the carriage and displaceable relative to the carriage along a transverse axis;
a tool arm extending from the lateral displacement member, the tool arm being articulated via a first joint between a first member and a second member; and
a tool support pivotally mounted to the tool arm via a second joint, the tool support adapted to receive the chipping or drilling tool.

2. The tool positioner as defined in claim 1, comprising an automated locking system operable to selectively restrict and enable multiple degrees of freedom of the tool support, the automated locking system configured for preventing a relative movement between the mast, the carriage and the lateral displacement member, the automated locking system activated upon actuation of the chipping or drilling tool.

3. The tool positioner as defined in claim 2, wherein the automated locking system includes a caliper and a disc rotatable relative to the caliper, wherein the caliper pinches the disc upon actuation of the caliper to lock rotation of the mast about the mast axis.

4. The tool positioner as defined in claim 3, wherein the automated locking system includes a clamp mounted to the carriage, the clamp, in an active position, engaging with the lateral displacement member to prevent movement of the lateral displacement member relative to the carriage.

5. The tool positioner as defined in claim 4, wherein the clamp and the caliper are actuatable via respective pneumatic actuators.

6. The tool positioner as defined in claim 1, wherein the first joint defines a first pivot axis, the second joint defines a second pivot axis, and the tool support defines a position and an orientation of the tool axis, and wherein the tool axis intersects with at least one of: the first pivot axis and the second pivot axis.

7. The tool positioner as defined in claim 6, wherein the tool axis intersects with both the first pivot axis and the second pivot axis.

8. The tool positioner as defined in claim 1, wherein the tool arm is securable to the lateral displacement member in an elevated mounting position and in a low mounting position, in the elevated mounting position the tool arm projects upwardly relative to the lateral displacement member.

9. The tool positioner as defined in claim 8, wherein the tool arm is pivotally mounted to the lateral displacement member via a third joint, the third joint lockable to selectively secure the tool arm in at least one of the elevated mounting position and the low mounting position.

10. The tool positioner as defined in claim 1, wherein the tool support includes a fixed member, a tool carriage displaceable along a tool axis relative to the fixed member, and an actuator operable to displace the tool carriage along the tool axis.

11. The tool positioner as defined in claim 10, further comprising a control unit including a pressure regulation valve configured to select a mode of operation between a low pressure mode and a high pressure mode, wherein in the low pressure mode, a pneumatic pressure delivered to the actuator is lower than a pneumatic pressure delivered to the actuator in the high pressure mode.

12. A tool positioner for a chipping or drilling tool having a tool axis, comprising:
a frame;
a tool support configured for coupling the chipping or drilling tool to the tool positioner, the tool support mounted to the frame via a first joint having a first pivot axis and a second joint having a second pivot axis, the first pivot axis, the second pivot axis and the tool axis intersecting each other at a common point, the first joint and the second joint allowing angular movements of the chipping or drilling tool at least about the respective first pivot axis and the second pivot axis, the tool support further displaceable relative to the frame to enable a plurality of degrees of freedom in translation of the tool support; and
an automated locking system operable to restrict and allow the plurality of degrees of freedom in translation of the tool support.

13. The tool positioner of as defined in claim 12, wherein the automated locking system is operable simultaneously upon actuation of the chipping or drilling tool.

14. The tool positioner as defined in claim 12, wherein the angular movement about the first pivot axis varies a pitch angle of the tool axis and the angular movement about the second pivot axis varies a yaw angle of the tool axis.

15. The tool positioner as defined in claim 12, wherein the frame includes a mast having a mast axis extending generally vertically, and a lateral displacement member displaceable along the mast axis to displace the tool support in translation therealong to allow a first one of the plurality of degrees of freedom in translation.

16. The tool positioner as defined in claim 15, wherein the lateral displacement member is further displaceable relative to the mast along a transverse axis, the transverse axis extending transversely relative to the mast axis to enable a second one of the plurality of degrees of freedom in translation of the tool support.

17. The tool positioner as defined in claim 15, wherein the mast is rotatable relative to the mast axis whereby a rotation of the mast causes a displacement of the tool support in a transverse direction relative to the mast axis.

18. The tool positioner as defined in claim 15, wherein the frame includes a carriage engaged to the mast and displaceable relative thereto along the mast axis, the carriage supporting the lateral displacement member.

19. The tool positioner as defined in claim 18, wherein the automated locking system includes an override mechanism configured to override a pneumatic supply of the automated locking system, the override mechanism including one or more mechanical locks to prevent any movements between the mast, the carriage and the lateral displacement member.

20. A method for operating a tool positioner for a chipping or drilling tool having a tool axis, the tool positioner having a frame and a tool support, the method comprising:
positioning the chipping or drilling tool relative to a working surface, including:
actuating a weight compensation system to move the tool support in translation relative to the frame along a first axis;
moving the tool support in translation relative to the frame along a second axis transverse to the first axis;
angularly displacing the tool support to cause a variation of at least one of a pitch angle and a yaw angle of the chipping or drilling tool; and
activating an automated locking system to prevent any further movements along the first axis and the second axis to restrict a first degree of freedom in translation and a second degree of freedom in translation of the chipping or drilling tool prior to or simultaneously with initiating drilling or chipping.
